(19) United States
(12) Patent Application Publication
(10) Pub. No.: US 2023/0392794 A1
(43) Pub. Date: Dec. 7, 2023

(54) MODULAR ELECTRIC PLATTER

(71) Applicants: Meitar SHUKRUN, Moshav Azricam (IL); Avraham SHUKRUN, Moshav Azricam (IL)

(72) Inventors: Meitar SHUKRUN, Moshav Azricam (IL); Avraham SHUKRUN, Moshav Azricam (IL)

(21) Appl. No.: 18/213,854

(22) Filed: Jun. 25, 2023

Related U.S. Application Data
(63) Continuation-in-part of application No. 17/829,396, filed on Jun. 1, 2022, now Pat. No. 11,707,159.

(51) Int. Cl. F24C 7/04; F24C 15/08; F24C 15/10

(52) U.S. Cl. CPC F24C 7/046; F24C 15/08; F24C 15/104

(57) ABSTRACT

A modular, two-story electric platter where more pots can be heated over the same ground surface. The second story may be removable or permanently attached to the first electric platter. An optional guard rail can protect the pots from falling off the electric platter.

### CROSS-REFERENCE

This application is a continuation-in-part of U.S. patent application Ser. No. 17/829,396, filed on Jun. 1, 2022, incorporated herein by reference in its entirety.

### TECHNICAL FIELD

The present invention relates to electric platters in general and in particular to modular, two-stories electric platters that can be assembled and disassembled.

### BACKGROUND ART

Electric platters are used to heat food. Jews who observe Sabbath use electric platters (turned on before the Sabbath or any other religious holiday) to heat food on Saturdays and on religious holidays so they don't turn on the stove top, manipulating gas or electricity, on Saturday or any other religious holiday. The size of the electric platters determines how many food containers (pots, bowls etc.) it can heat, and if one needs to heat more food beyond the capacity of the platter, then one needs to use an additional electric platter.

### SUMMARY OF INVENTION

The present invention relates to a modular, two-story electric platter where more pots can be heated over the same ground surface. The second story may be removable or permanently attached. An optional guard rail can protect the pots from falling off the electric platter. The guard rail may be only for the top heating surface or for both.

The present invention relates to a modular electric platter, comprising:
(i) a first autonomous heating surface including an electric connector adapted to connect to an electric outlet and a plurality of first connection elements, wherein the first heating surface can be used as a stand-alone, autonomous electric platter;
(ii) a second heating surface including a plurality of second connection elements, removably attached to the first heating surface; and
(iii) a plurality of connection pillars detachably connected to the first and second connection elements, thus connecting the first heating surface and the second heating surface, so that the second heating surface is positioned above the first heating surface,
wherein the second heating surface is electrically connected to the first heating surface, via electric wires in at least one connection pillar.

In some embodiments, the connection pillars are vertical.

In some embodiments, the second connection elements are permanently connected to the connection pillars.

In some embodiments, the first heating element further comprises a surrounding guard rail.

In some embodiments, the second heating element further comprises a surrounding guard rail.

In some embodiments, the second heating element further comprises an independent electric connection adapted to connect to an electric outlet.

In some embodiments, the second heating surface comprises an on-off switch.

In some embodiments, the on-off switch is coupled to the first heating surface.

In some embodiments, the first and second heating surfaces are turned on and off together.

In some embodiments, the first and second heating surfaces are turned on and off separately.

### BRIEF DESCRIPTION OF DRAWINGS

FIG. 1 shows a first heating surface.

FIG. 2 shows an embodiment of an electric platter of the invention with a first and a second heating surfaces.

FIGS. 3A-3B show embodiments of connection pillars.

### MODES FOR CARRYING OUT THE INVENTION

In the following detailed description of various embodiments, reference is made to the accompanying drawings that form a part thereof, and in which are shown by way of illustration specific embodiments in which the invention may be practiced. It is understood that other embodiments may be utilized, and structural changes may be made without departing from the scope of the present invention.

The present invention relates to a modular electric platter, comprising:
(i) a first autonomous heating surface including an electric connector adapted to connect to an electric outlet and a plurality of first connection elements, wherein the first heating surface can be used as a stand-alone, autonomous electric platter;
(ii) a second heating surface including a plurality of second connection elements, removably attached to the first heating surface; and
(iii) a plurality of connection pillars detachably connected to the first and second connection elements, thus connecting the first heating surface and the second heating surface, so that the second heating surface is positioned above the first heating surface,
wherein the second heating surface is electrically connected to the first heating surface, via electric wires in at least one connection pillar.

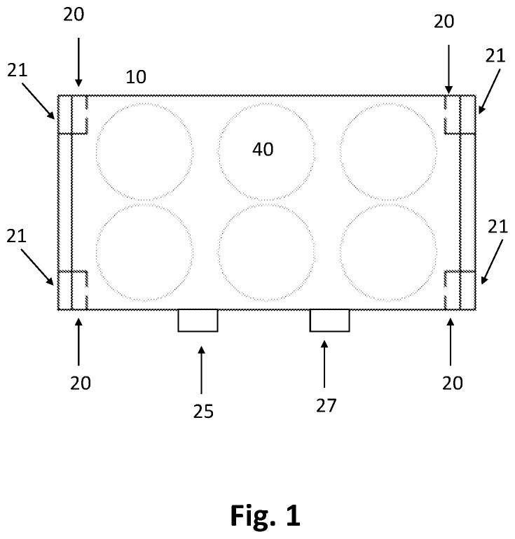

Reference is now made to FIG. 1 showing a first heating surface 10 and first connection elements 20 or 21 on each corner of the first heating surface 10. The connection element 20 may fit an external connection pillar (not shown), that is the connection pillar is external to the heating surface 10. The connection element 21 may fit an internal connection pillar 80 (not shown), that is the connection pillar 80 is on the surface of the heating surface 10. A plurality of food containers, in different sizes (e.g. pots) 40 can be placed on top of the heating surface 10 (the container positions are shown for illustrations purposes only). Optionally, a surrounding guard rail 50 (not shown) can be removably or permanently positioned on the perimeter of the heating surface 10 so that the pots 40 don't accidently tip off the electric platter.

The first heating surface 10 is an autonomous, stand-alone unit that can be used independently as an electric platter. The first heating surface 10 comprises an electric connector 25 adapted to connect to an electric outlet (not shown) to receive power, and an on/off switch 27 to turn the unit on and off.

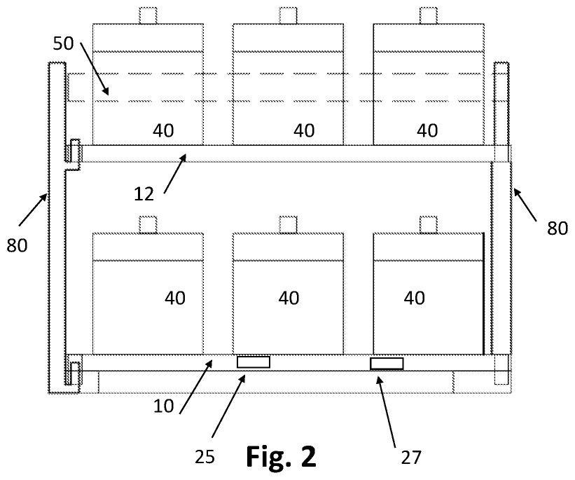

FIG. 2 shows the electric platter of the invention wherein a second heating surface 12 is positioned above the first heating surface 10. The second heating surface 12 comprises a plurality of second connection elements 20/21 (not shown). The first connection elements 20/21 and the second connection elements 20/21 removably connect to connection pillars 80 so that the second heating surface is positioned above the first heating surface. The connection pillars 80 are vertically positioned between the horizontal first and second heating surfaces 10, 20.

In some embodiments, the first and second heating surfaces 10, 12 are turned on and off together via the on/off switch 27.

Optionally, a surrounding guard rail 50 can be removably or permanently positioned on the perimeter of the heating surface 10 and/or 12 so that the pots 40 don't accidently tip off the electric platter.

In some embodiments, the first and second heating surfaces 10, 12 are turned on and off separately (individually), and in this case the second heating surface 12 also comprises an independent on/off switch (not shown).

The first and second heating surfaces 10, 12 can have a shared electric connection or have separate, individual electric connections.

In some embodiments, the second heating surface 12 is electrically connected to the first heating surface 10, via electric wires in at least one connection pillar 80. The first and second heating surfaces 10, 12 can have a shared electric connection by connecting the first and second heating surfaces 10, 12 via electric cables running through at least one connection pillar 80.

In some embodiments, additional heating surfaces may be positioned on top of the second heating surface 12, that is 3 or 4 or more heating surfaces one on top of the other.

In some embodiments, the second heating surface 12 can have an on-off switch, that can be coupled, for example, to the first and second heating surface 10.

The modular, electric platter of the invention can be conveniently assembled and disassembled, so that the two heating surfaces 10, 12 and the connection pillars 80, are all taken apart and conveniently stored in a compact form (compared to the assembled structure).

The first heating surface 10, can be used as an autonomous heating surface, and when the need arises to reheat more pots, the second heating surface 12 can be assembled by connecting the connection pillars 80.

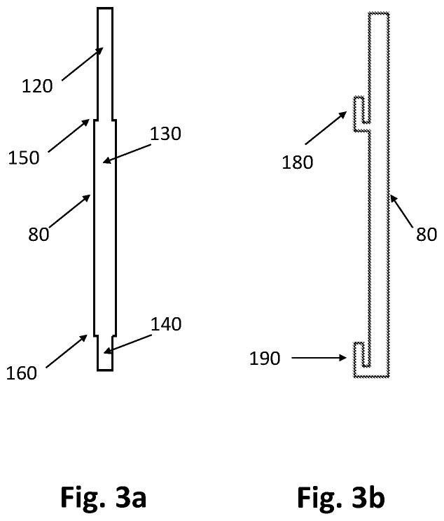

FIGS. 3A-3B show different embodiments of connection pillars 80.

FIG. 3A shows an embodiment of an internal connection pillar 80 (shown on the right side of FIG. 2) having a top portion 120 that is narrower than a middle portion 130 such that the top of the middle portion 130 serves as a break 150 when inserting the second heating surface 12. A bottom portion 140 of the connection pillar 80 is narrower than the middle portion 130 such that the bottom portion 140 can enter an opening 21 in the first heating surface 10. In the embodiment of FIG. 3A, the connection elements 21 of the first and second heating surfaces 10, 12 are openings adapted to the size of the connection pillars 80. The connection pillar 80 may be preferably removably connected to the first heating surface 10 or permanently connected to the first heating surface 10.

FIG. 3B shows an embodiment of connection pillar 80 (shown on the left side of FIG. 2) having a top hook 180 adapted to connect to a second connection element and a bottom hook 190 adapted to connect to a first connection element 20. In the embodiment of FIG. 3A, the connection elements 20 of the first and second heating surfaces 10, 20 are openings adapted to be coupled to the top hooks 180 and bottom hooks 190.

In some embodiments, the first connection elements 20 are permanently connected to the connection pillars 80.

In some embodiments, the first connection elements 20 are detachably connected to the connection pillars 80.

In some embodiments, the second connection elements are permanently connected to the connection pillars 80.

In some embodiments, the second connection elements are detachably connected to the connection pillars 80.

The first connection elements 20 may be identical or different from the second connection elements.

Although the invention has been described in detail, nevertheless changes and modifications, which do not depart from the teachings of the present invention, will be evident to those skilled in the art. Such changes and modifications are deemed to come within the purview of the present invention and the appended claims.

1. A modular electric platter, comprising:
(i) a first autonomous heating surface including an electric connector adapted to connect to an electric outlet and a plurality of first connection elements, wherein the first heating surface can be used as a stand-alone, autonomous electric platter;
(ii) a second heating surface including a plurality of second connection elements, removably attached to the first heating surface; and
(iii) a plurality of connection pillars detachably connected to the first and second connection elements, thus connecting the first heating surface and the second heating surface, so that the second heating surface is positioned above the first heating surface,
wherein the second heating surface is electrically connected to the first heating surface, via electric wires in at least one connection pillar.

2. The electric platter of claim 1, wherein the connection pillars are vertical.

3. The electric platter of claim 1, wherein the second connection elements are permanently connected to the connection pillars.

4. The electric platter of claim 1, wherein the first heating element further comprises a surrounding guard rail.

5. The electric platter of claim 1, wherein the second heating element further comprises a surrounding guard rail.

6. The electric platter of claim 1, wherein the second heating element further comprises an independent electric connection adapted to connect to an electric outlet.

7. The electric platter of claim 1, wherein the second heating surface comprises an on-off switch.

8. The electric platter of claim 9, wherein said on-off switch is coupled to the first heating surface.

9. The electric platter of claim 1, wherein the first and second heating surfaces are turned on and off together.

10. The electric platter of claim 1, wherein the first and second heating surfaces are turned on and off separately.
